(19) United States
(12) Patent Application Publication
(10) Pub. No.: US 2020/0141592 A1
(43) Pub. Date: May 7, 2020

(54) SMART TEMPERATURE CONTROL SYSTEM WITH ARTIFICAL INTELLIGENCE TECHNOLOGY AND METHOD OF USE

(71) Applicant: Omer Shahzad, Arlington, TX (US)

(72) Inventor: Omer Shahzad, Arlington, TX (US)

(21) Appl. No.: 16/179,372

(22) Filed: Nov. 2, 2018

(51) Int. Cl. F24D 19/10; G05D 23/19; F24F 11/30

(52) U.S. Cl. CPC F24D 19/1084; F24F 11/30; G05D 23/1931

(57) ABSTRACT

A smart temperature control system includes a thermostat positioned within an interior of a building and having a communication module; a temperature sensor for measuring an interior temperature of the building; and a processor to manipulate one or more settings of the thermostat, the processor having an artificial intelligence module to process data to provide a command to be implemented via the processor and thermostat to adjust the interior temperature based on the command; an exterior temperature sensor to determine an exterior temperature; the exterior temperature is communicated to the processor to create the command; and the command based on the exterior temperature causes the thermostat to switch between a heat setting and a cool setting to maintain a predetermined set temperature.

### BACKGROUND

### 1. Field of the Invention

The present invention relates generally to temperature control systems, and more specifically, to a smart temperature control system with artificial intelligence to provide for adaption to behaviors and environments to maintain a predetermined temperature within a building.

### 2. Description of Related Art

Temperature control systems are well known in the art and are effective means to alter a temperature within a building. For example, FIG. 1 depicts a flowchart 101 of a conventional temperature control system, wherein a thermostat in installed and the user manipulates the thermostat by setting to cool or heat, and setting a predetermined temperature, as shown with boxes 103, 105. The thermostat then communicates with the cool or heat system to maintain the temperature, as shown with box 107. In this system, fluctuations in the exterior temperature are not appropriately accounted for, as shown with box 109. For example, if the temperature drops below the set temperature, the thermostat will not switch to heat as needed to maintain the temperature, this function requires the user to switch to heating.

Accordingly, although great strides have been made in the area of temperature control systems, many shortcomings remain.

The system of the present invention provides for an improved temperature control system, wherein the thermostat is configured to receive commands and adjust based on an exterior temperature sensor, and therefore provide for a more constant interior temperature, as is desirable by the user.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a conventional temperature control method;

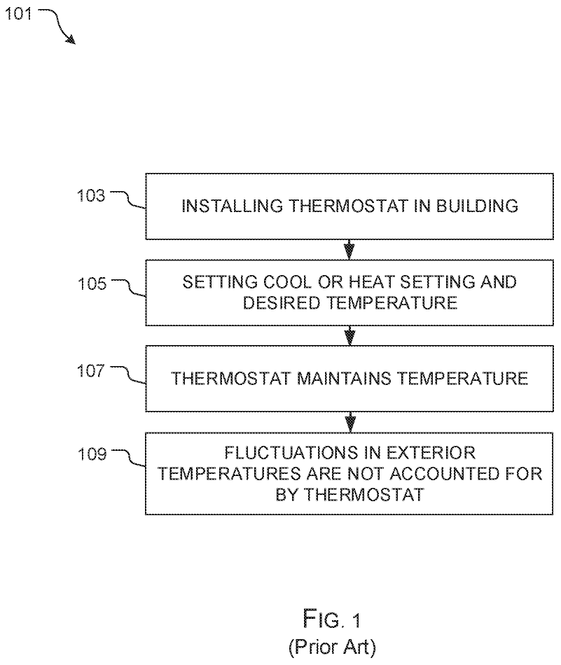

FIG. 2 is a diagram of a smart temperature control system in accordance with a preferred embodiment of the present application;

FIG. 3 is a simplified schematic of the thermostat of FIG. 2; and

FIG. 4 is a flowchart of the method of use of the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional temperature control systems. Specifically, the present invention provides for artificial intelligence technology incorporated into a thermostat, wherein an exterior temperature sensor sends communication to the thermostat, and the thermostat adjusts based on exterior temperature. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

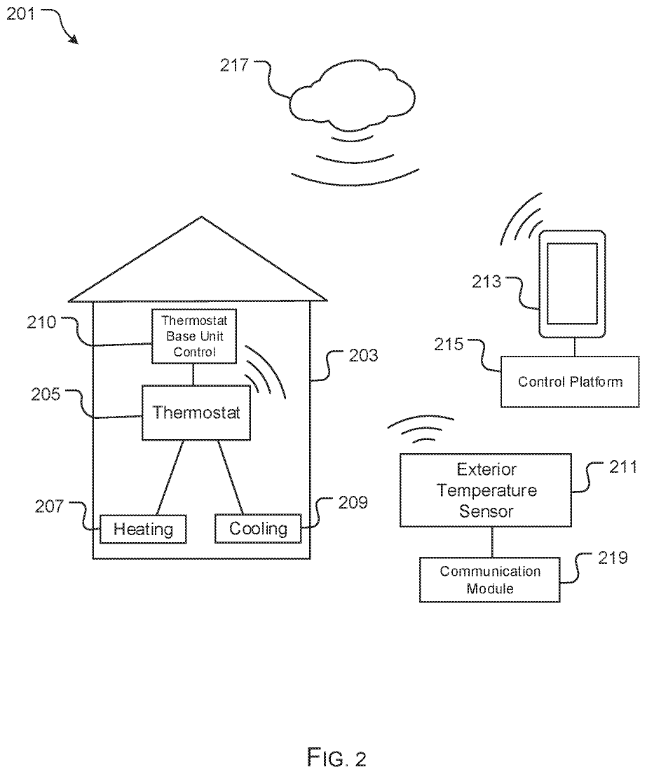

Referring now to the drawings wherein like reference characters identify corresponding or similar elements throughout the several views, FIG. 2 depicts a diagram of a smart temperature control system 201 in accordance with a preferred embodiment of the present application. It will be appreciated that system 201 overcomes one or more of the above-listed problems commonly associated with conventional temperature control systems.

In the contemplated embodiment, system 201 includes a building 203 having a thermostat 205 placed within the interior of the building, the thermostat being in communication with a heat system 207 and a cool system 209 of the building 203. The thermostat further includes a base unit control 210 wherein the user can input commands to control the system. System 201 further includes an exterior temperature sensor 211 positioned on or around an exterior area of the building 203. It should be appreciated that the exterior temperature sensor does not have to be attached directly to the building and can merely be in the same vicinity.

System 201 can further include a mobile device 213, such as a mobile phone, having a platform 215 for user control. It should be appreciated that wireless communication is facilitated within system 201 via any known means, such as through use of a network 217. In the preferred embodiment, the exterior temperature sensor 211 includes a communication module 219 for facilitating wireless communication. Communication module 219 can include one or more transeiver or the like to facilitate communication with thermostat 205 and/or mobile device 213.

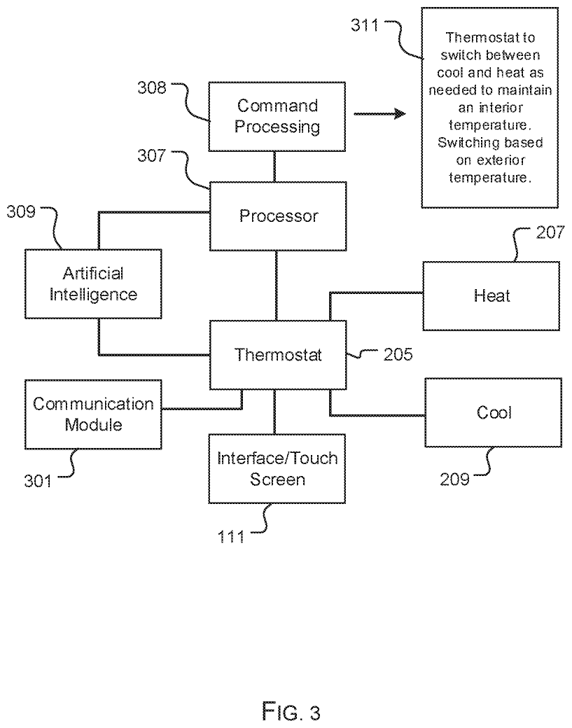

In FIG. 3, a simplified schematic depicts components of thermostat 205. As discussed, thermostat 205 is in communication with heating 207 and cooling 209 systems of the building and configured to thereby activate heating and cooling of the building. Further included is a communication module 301, which can include one or more transceivers, chips, or the like to facilitate communication and receive commands from the mobile device and/or exterior temperature sensor.

In the preferred embodiment, the thermostat 205 further includes a user interface 303, such as a touch screen, wherein the user can set temperatures, manually activate controls, and the like.

Thermostat 205 further includes a processor 307 configured to receive data, and process commands 308 to alter the settings and functionality of thermostat 205. Artificial intelligence technology 309 is implemented through processor 307, wherein the processor can manipulate the thermostat 205 based on behaviors of the user, as well as other data, including the exterior temperature. As shown with box 311, the processor is configured to switch between cooling and heating based on an exterior temperature change. For example, if the user sets a predetermined set temperature to be maintained in the building at 72 degrees, and then the exterior temperature drops below 72 degrees, this data will provide a command for the thermostat to switch from cooling to heating, thereby ensuring constant interior temperature maintenance.

It should be appreciated that one of the unique features believed characteristic of the present application is the incorporation of artificial intelligence technology, along with the se of an exterior temperature sensor, to better maintain temperature control.

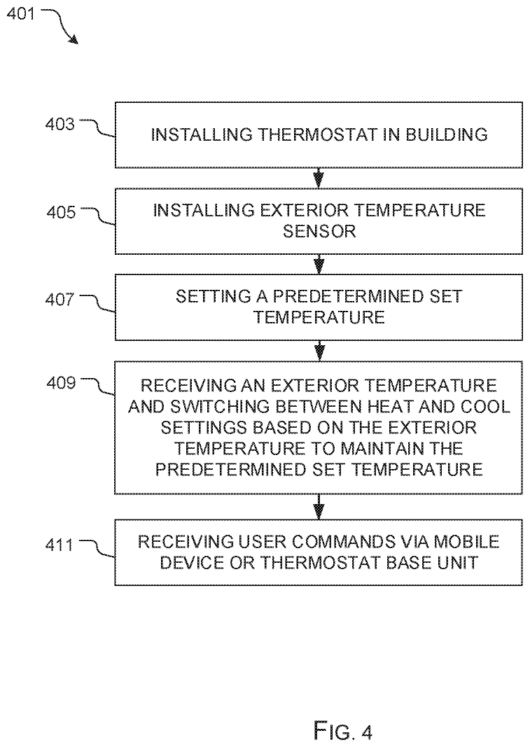

In FIG. 4, a flowchart 401 depicts a method of use associated with system 201. During use, the user installs the thermostat within the interior of the building and installs the exterior temperature sensor outside of the building, as shown with boxes 403, 405. The user then sets a predetermined set temperature based on the preference, as shown with box 407. The thermostat is then configured to switch between heating and cooling based on the exterior temperature dropping or rising above or below the predetermined set temperature to ensure constant temperature, as shown with box 409. It is contemplated that the user can either use their mobile phone or the thermostat base unit to control the system and provide commands, as shown with box 411.

It should be appreciated that the thermostat can include any other known features in the art.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A smart temperature control system, comprising:
a thermostat positioned within an interior of a building, the thermostat having:
a first communication module configured to provide wireless communication;
a temperature sensor for measuring an interior temperature of the building; and
a processor configured to manipulate one or more settings of the thermostat, the processor having an artificial intelligence module configured to process data to provide a command to be implemented via the processor and thermostat to adjust the interior temperature based on the command;
an exterior temperature sensor positioned at an exterior of the building and configured to determine an exterior temperature, the exterior temperature sensor having:
a second communication module configured to provide wireless communication;
wherein the exterior temperature is communicated to the processor to create the command; and
wherein the command based on the exterior temperature casues the thermostat to switch between a heat setting and a cool setting to maintain a predetermined set temperature.

2. The system of claim 1, further comprising:
a mobile computing device configured to communicate with the thermostat and the exterior temperature sensor, the mobile computing device having an interface to receive user commands to be transmitted to the thermostat.

3. The system of claim 1, wherein the thermostat further comprises:
a touch screen for user manipulation.

4. A method of temperature control, the method comprising:
installing a thermostat within an interior of a building, the thermostat having a first communication module and a processor configured to manipulate one or more settings of the thermostat based on artificial intelligence technology;
installing an exterior temperature sensor on an exterior of the building, the exterior temperature sensor having a second communication module to communicate with the thermostat;
receiving a predetermined set temperature from a user;
receiving an exterior temperature by the thermostat from the exterior temperature sensor; and
switching, via the processor, between a heat and a cool setting associated with the thermostat based on the exterior temperature to maintain the predetermined set temperature.

5. The method of claim 4, further comprising:
receiving a command from a user via a mobile computing device configured to communicate with the thermostat.
